(19) United States
(12) Patent Application Publication
(10) Pub. No.: US 2024/0289698 A1
(43) Pub. Date: Aug. 29, 2024

(54) HORIZONTAL FEDERATED REGRESSION RANDOM FOREST WITH SECURE AGGREGATION

(71) Applicant: Dell Products L.P., Round Rock, TX (US)

(72) Inventors: Paulo Abelha Ferreira, Rio de Janeiro (BR); Adriana Bechara Prado, Niterói (BR)

(21) Appl. No.: 18/176,106

(22) Filed: Feb. 28, 2023

(51) Int. Cl. G06N 20/20

(52) U.S. Cl. CPC G06N 20/20

(57) ABSTRACT

A horizontal federated random forest regressor with secure aggregation is disclosed. When constructing a node of a decision tree, multiple potential splits are performed at each of multiple edge nodes using local data. Federated variance data, which includes sums, is generated and transmitted to a central node. Using the sums, a global variance can be determined for each of the splits without requiring the individual nodes to share the specific samples. The split with the lowest global variance is selected by the central node and implemented for the node of the decision tree at each of the edge nodes. A random forest regressor can be constructed and trained such that each of the edge nodes includes the same random forest regressor with the same splits for the features at the nodes of the decision trees that constitute the random forest regressor.

### RELATED APPLICATIONS

This application is related to U.S. Ser. No. 17/937,225 filed Sep. 30, 2022 and titled HORIZONTAL FEDERATED FOREST VIA SECURE AGGREGATION, which application is incorporated by reference in its entirety.

### FIELD OF THE INVENTION

Embodiments of the present invention generally relate to federated learning. More particularly, at least some embodiments of the invention relate to systems, hardware, software, computer-readable media, and methods, for training random forest (RF) regression models in a federated learning (FL) setting, while using a secure aggregation process to enhance and maintain data privacy and to constructing a regression decision tree.

### BACKGROUND

Random forest models include multiple decision trees that may operate collectively to generate an output. Random forests can handle both classification and regression problems. For classification tasks, the output of the random forest is the class selected by the most decision trees. For regression tasks, the mean or average prediction of the individual decision trees may be returned.

Random forests have many different applications. For example, random forests may be used in an employment setting. More specifically, predicting the success of future employees based on current employees, as is done with custom algorithmic pre-employment assessments, potentially reduces the chance of increasing diversity in a company because this process inherently skews the task toward finding candidates resembling those who have already been hired. Indeed, very few companies disclose specifics on how these tools perform for a diverse group of applicants, for example, with respect to gender, ethnicity, race, age, and/or other considerations, and if/how the company can select candidates in a fair, and explainable, way. Also, companies may be shielded by intellectual property laws and privacy laws, such that the companies cannot be compelled to disclose any information about their models and how their models work. More transparency is necessary to better evaluate the fairness and effectiveness of tools such as these and machine learning models such as random forest models may aid in providing this transparency.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an example decision tree that may be included in a random forest model;

FIG. 2 discloses aspects of federated learning using machine learning models;

FIG. 3 discloses aspects of an overview of an example secure aggregation protocol;

FIG. 4 discloses aspects of an example binning method for continuous features;

FIG. 5A-5B discloses aspects of a decision tree including a variance for a feature split;

FIG. 5C discloses aspects of collecting federated variance data at a central node;

FIG. 6 discloses aspects of determining a global variance for each of multiple feature splits performed at multiple edge nodes;

FIG. 7 discloses aspects of an example method according to some embodiments for constructing a node of a decision tree and setting a split for a decision tree node globally;

FIG. 8 discloses aspects of an example method for constructing a node of a decision tree and setting a same split for the node of the decision trees at each of multiple edge nodes;

FIG. 9 discloses an example computing entity operable to perform any of the disclosed methods, processes, and operations.

### DETAILED DESCRIPTION OF SOME EXAMPLE EMBODIMENTS

Embodiments of the present invention generally relate to federated learning. More particularly, at least some embodiments of the invention relate to systems, hardware, software, computer-readable media, and methods, for training random forest (RF) regression models in a federated learning (FL) setting, while using a secure aggregation process to enhance and maintain data privacy.

In general, some example embodiments of the invention are directed to a protocol for horizontal federated regression forest via secure aggregation. Aspects of random forest classification relate to aspects of random forest regression. Embodiments of the protocol, with respect to classification decision trees, include the insight that most, if not all, purity measures for splitting nodes during decision tree construction require (1) counting the number of feature-value occurrences, or bins in the case of continuous features, per possible label, and (2) knowing the total number of samples per feature-value, in order to normalize the sum into a probability. Training regression random forests requires the calculation of purity measures that involve other non-trivial calculations, such as reduction in variance.

Embodiments of the invention relate to a framework that allow more complex purity measures, including those used for random forest regression models, to be determined.

Embodiments relate to constructing random forest regression decision trees in a private manner from all edge nodes of a federated learning system. The following discussion includes aspects of random forest classification that relate to random forest regression.

Applied in this context, a secure aggregation protocol may enable the computation of sums of values, while still preserving the privacy of each component, or edge node, that contributes to the sum. Additionally, some embodiments may also compute the total count for a given feature by performing secure aggregation on the individual counts. To this end, some embodiments may define and implement a protocol that uses secure aggregation to compute the purity (splitting) value for each feature and thus construct a common decision tree and an associated random forest regressor that includes the decision tree, in a private manner from all edge nodes. Embodiments may also employ a scheme for privately computing possible ranges for continuous features.

The following is an overview concerning aspects of some example embodiments of the invention. This discussion is not intended to limit the scope of the invention, or the applicability of the embodiments, in any way. Further, while reference is made to application of some embodiments in a job candidate screening and hiring process, such application is provided only by way of illustration and is not intended to limit the scope of the invention in any way. Thus, some embodiments may be applicable in other fields as well including, but not limited to, activities such as medical diagnosis, self-driving cars, sales projections, HR (Human Resource) decisions, and hardware prototyping.

Regarding human resource decisions, a fair and thorough candidate screening process is a vital process for the overall company's fairness, diversity, and inclusion goals. According to the literature, there are four main distinct stages of the hiring pipeline, namely, sourcing, screening, interviewing, and selection. Sourcing includes building a candidate pool, which is then screened to choose a subset to interview.

An example application for some embodiments of the invention concerns job candidate screening, particularly, some embodiments may be directed to approaches for obtaining a fair screening that leads to a diverse pool of candidates to be considered. With the current advent of machine learning (ML) in many different areas, it is no surprise that candidate screening is currently also being partly automated. One example of such automation is the classification of candidates based on personality trait features such as, for example, the introvert to extrovert spectrum, or the candidate enthusiasm spectrum.

However, many of the successful classification models can be biased or opaque to explainability. As such, there is interest in using models that are more explainable by nature to provide transparency, as it is the case of decision trees/random forests. Explainable artificial intelligence (XAI) is a growing area of research where one is interested in understanding the rationale behind the output or decision of an AI model. This may be of interest now that AI models are deployed in high-risk/high-cost activities such as, but not limited to, areas including medical diagnosis, self-driving cars, sales projections, HR decisions and hardware prototyping. Explainability can help in accountability, decision-making, model management and in constructing insights from models.

Random forests are effective and transparent machine learning models capable of regression and classification. At present however, there are no Federated Learning protocols for training random forest regressors in the horizontal federated learning setting, in which edge nodes share features, but not samples, while using secure aggregation to enhance privacy. Thus, some example embodiments are directed to a protocol for horizontal federated regression random forest via secure aggregation.

A random forest regressor can predict a numeric value using decision trees. For example, consider the problem related to candidate screening, in which one may be interested in predicting scores from personality trait features (e.g., introvert to extrovert spectrum or enthusiasm spectrum), which are the input values to a prediction model. For a single input, each attribute may be referred to herein as a feature. One example of a machine learning model that can perform such a task is a random forest regressor.

A random forest regressor can predict a numeric value using decision trees. Each decision tree runs the input through a series of inequality tests over its feature-values until it ends up in a leaf of the decision tree. The leaf containers the predicted numeric value for the given input. In a random forest regressor, the output of all decision trees are considered when generating the output.

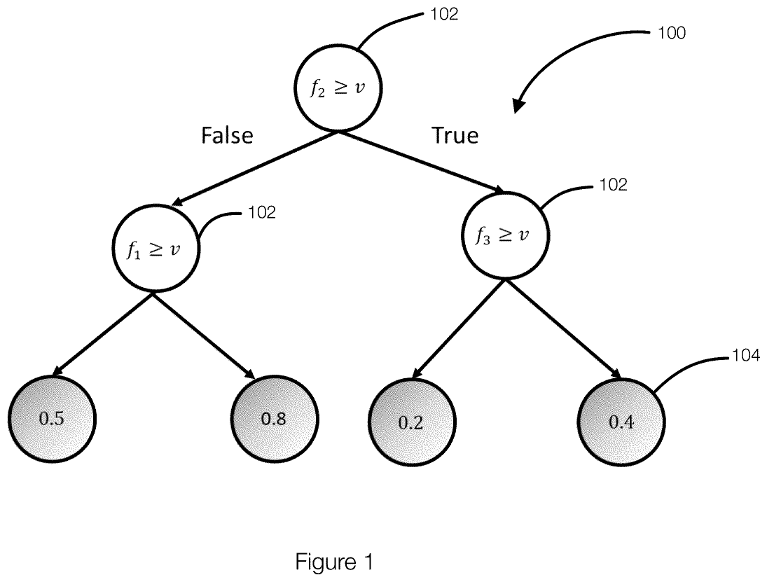

FIG. 1 discloses aspects of a decision tree, which is denoted at 100. With reference to the decision tree 100, assume an input X having three features called f₁, f₂, and f₃. To predict the class for X, that is, the classification of X, such input runs through the decision tree 100 and passes a series of inequality tests 102 over its attribute-values. That is, each node corresponds to a particular feature and the input either possesses a particular value of that feature, or it does not. When the answer is negative, the input goes to the left, and when the answer is positive, the input runs to the right. Each inequality test, which by their nature are binary, directs the input towards a subset of internal nodes until the input reaches a leaf 104.

Thus, for example, if the value of feature f₂ for the input is greater than, or equal, to value v in the node 102 of the tree 100, then the input runs to the right where feature f₃ is assessed. Continuing, if the value of feature f₃ for the input is greater than, or equal, to value v in the node 102, then the input runs to the right and ends at the leaf 104 indicating a value of 0.4. The value of v in the nodes may vary. The decision tree thus arrives on one of the leaves based on the decisions at the various nodes of the tree 100.

A decision tree regressor may be trained or learned from data observations or examples. A random forest regressor may comprise many different decision trees whose results may be compiled (e.g., averaged) into a final output. The idea behind applying many decision trees is to increase variability and decrease the chance of overfitting the training data, that is, applying a single decision tree that is too fine-tuned to the training set and performs poorly in the test set.

Random forest models may have various advantages over other machine learning models for classification. Particularly, random forests may: (1) require few hyperparameters—that is, parameters that may need to be set a priori and cannot be learned; (2) be efficient to build and not require complex infrastructure for learning; (3) be efficient to execute when predicting; and (4) be more explainable than other black-box models, such as Neural Networks (NN).

Federated learning is a machine learning technique where the goal is to train a centralized model while the training data, used to train the centralized model, remains distributed on many edge (e.g., client) nodes. Usually, the network connections and the processing power of such edge nodes are comparatively less than the resources of a central node. In federated learning, as disclosed herein, edge nodes can collaboratively learn a shared machine learning model, such as a deep neural network or random forest, for example, while keeping the training data private on the edge device (edge node). Thus, the model can be learned or trained without storing a huge amount of data in the cloud, or in the central node. Every process that involves many data-generating edge nodes may benefit from such an approach, and these examples are countless in the mobile computing world.

In the context of federated learning, a central node can be any machine (or system) with reasonable computational power or resources (processors, memory, networking hardware). The central node receives updates from the edge nodes and aggregates these updates on the shared model. An edge node may be any device (e.g., computing device with processors, memory, networking hardware) or machine that contains or has access to data that will be used to train the machine learning model. Examples of edge nodes include, but are not limited to, connected cars, mobile phones, IoT (Internet of Things) devices, storage systems, and network routers.

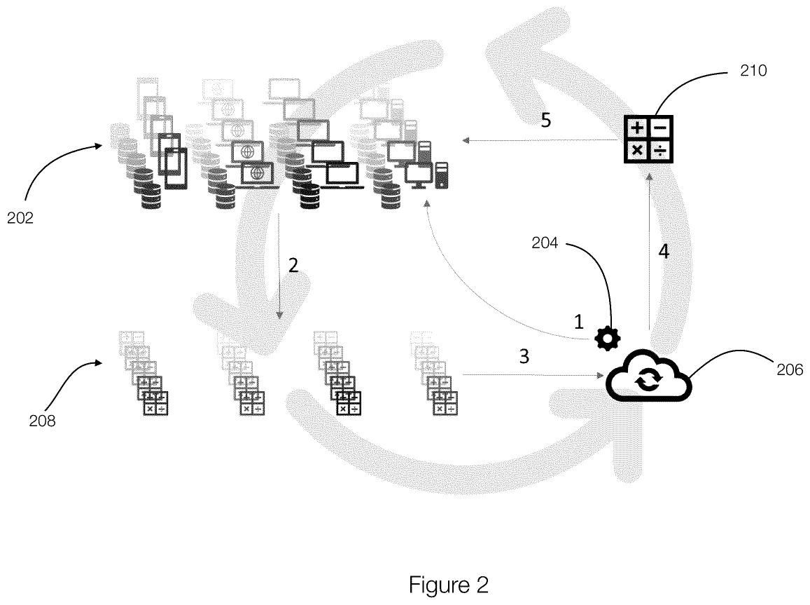

The training of a neural network in a federated learning setting, shown in the example method of FIG. 2, may operate in the following iterations, sometimes referred to as ‘cycles’:
1. the edge nodes 202 download the current model 204 from the central node 206—if this is the first cycle, the current (or initial) model may be randomly initialized;
2. then, each edge node 202 trains the model 204 using its local data during a user-defined number of epochs;
3. the model updates 208 are sent from the edge nodes 202 to the central node 206—in some embodiments, these updates may comprise vectors containing the gradients;
4. the central node 206 may aggregate these vectors and update the shared model 210; and
5. when the pre-defined number of cycles N is reached, finish the training—otherwise, return to 1.

Model updates transferred between nodes in federated learning still carry information that may be used to infer properties of, or sometimes recover part of, the data used for training. To overcome this weakness or to provide strong privacy guarantees, the federated learning framework described above incorporates a secure aggregation protocol.

Thus, instead of having access to each client update, the server or central node will only have access to a sum of the client updates. More concretely, a protocol may be implemented where the server can only learn the sum of K inputs, but not the individual inputs, where these inputs may be the, relatively large, machine learning model update vectors from each client.

With some embodiments of this protocol, individual users, such as edge nodes, may construct pairwise masking vectors that cancel each other out when summed at the central node. The protocol may begin with an exchange of pairwise keys through a scheme such as the Diffie-Hellman key agreement, for example. Each pairwise key may be used as a seed to a pseudo-random number to generate 0-sum masks for each pair of clients. There is also a part of the protocol for dealing with user dropout, and this may involve a Shamir secret sharing scheme.

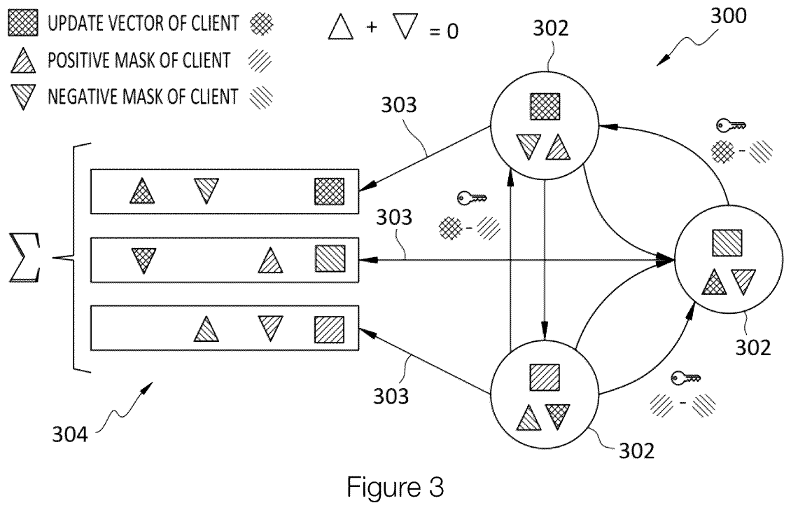

In FIG. 3, there is disclosed a graphical representation 300 of a Secure Aggregation protocol, where three nodes 302, or clients in FIG. 3, construct pairwise masks that may be transmitted to the central node 304 as vectors 303, and which may cancel each other out at the central node 304. If a malicious or curious attacker has access to one of the vectors 303 coming from a given participant node 302, the attacker could not access any information since the vector has all the halves from all pairwise masks from each client 302. The secure aggregation protocol may thus enable calculation of the sum of distributed vectors from a group of nodes, while guaranteeing that zero information about any particular edge node can be obtained by an entity that accesses only one of the vectors 303.

The following section discusses aspects of example embodiments of such a protocol, and because decision trees are often referred to as including nodes, and the discussion also refers to edge nodes (e.g., client devices), the following discussion will use a different terminology for the purposes of clarity. However, the use of the term node and reference to an edge node or a tree node may also be clear from context.
Tree: A Decision Tree
Node: A node of a tree
Central Node: The central computation device (for example, a Near Edge, or a Cloud)
Edge Node: An edge device (for example, a local computation infrastructure of a customer.

There are many variations on the algorithm for constructing a random forest model. Some embodiments of the invention comprise a distributed and federated protocol for constructing decision trees that may compose the random forest ensemble. The protocol may be a version of horizontal federated learning and so it may be assumed, for the purposes of some embodiments at least, that all edge nodes share the same features across datasets, albeit the edge nodes may not be sharing the same samples. In some embodiments, all edge nodes participate in the construction of all decision trees, and the decision trees are constructed one by one. The algorithm for constructing a tree is recursive and some embodiments may construct a tree node by node.

This section focuses on aspects that are key to maintaining the privacy of edge nodes and their respective data. Many aspects of random forest construction, such as bagging, for instance, are considered. In such a case, each edge node may select a subset of its own samples to be considered for each tree, but this does not typically influence privacy. The same may be true for other aspects of the general random forest construction algorithm, but some embodiments may place particular emphasis on aspects that could compromise privacy, such as the privacy of data at one or more edge nodes, that is, aspects such as calculating feature characteristics, and splitting measures.

In some embodiments, the protocol may start with a central node broadcasting the start of a new random forest model to all selected edge nodes. Also, at the start of the construction of each decision tree, the central node may broadcast, to the edge nodes, the beginning of a new decision tree. It is also possible for the central to samples a subset of all features that will be used for each decision tree and broadcast this to the edge nodes.

Prior to starting to construct a decision tree, each edge node may sample its own dataset (with replacement) to decide on the samples that will be used for the current tree. Then, each tree starts at the root node and each consecutive node is built recursively in the same manner as described below. Note that all nodes of all decision trees may be created by all edge nodes so that in the end, there is a unique random forest model shared by all the edge nodes.

In a non-specific version of the random forest algorithm, to build a node of a decision tree, there may be a need to decide on the best split for that node (e.g., what is the inequality). To compare splits, embodiments may calculate the node purity that would be achieved if a particular feature split were selected. The feature split yielding the highest purity of the target value is selected for that node. A given node purity is calculated based on the combined purity calculated for its child nodes. Note that as used herein, ‘purity’ includes the notion that for a given feature split at a given node, the inputs that possess the target value classes as closely balanced as possible with the inputs that do not possess the target values balanced. For example, given 10 inputs to a node associated with a particular feature split, highest purity would be reflected by an even feature split into two child nodes such that one of the child nodes has all 5 target values of the same given class and the other child node has the other 5 target values of another given class. In one example, the split is based on a value of a feature while the purity may be based on a label. For example, a node may split on height. A feature split at a node being constructed may be: height >63 inches? The purity of the node is based on how well the node split male or female classes, which may be determined by evaluating the child nodes.

To list all possible splits, all features may be categorized. Discrete features may be naturally categorized into the possible discrete values, while continuous features, on the other hand, may need to be binned, that is, divided into discrete ranges.

In the distributed case, all edge nodes may share the same features, but they might have different values for each feature. However, the edge nodes may need to agree on the categorization of all features for the split comparisons to make sense. Therefore, the edge nodes may jointly decide on what will be the categorizations of each feature, but the edge nodes may do so privately. Example embodiments of an approach for this are discussed below and is an example of federated feature categorization. This federated feature categorization may be done only once, at the start of a new random forest construction protocol.

After all features have been categorized, embodiments may perform comparable splits on all edge nodes. At the construction of every node, each edge node may perform a purity calculation considering all splits of all features, or a selected subset thereof. For each feature split, the yielded purity may be calculated. The central node may consider the resulting purity coming from all the edge nodes, without revealing an undue amount of private information from any of the edge nodes. This may be done through a federated purity calculation scheme, described below.

Once the purity for all feature splits has been calculated, the central node may broadcast the winning feature split, that is, the feature split with the highest purity (e.g., as measured or determined by a global variance for random forest regressors), and each edge node will then know the best feature split to use to construct the current node. Then, embodiments may recursively step towards the next node and repeat the same process, but now for the subset of samples that arrive at the current node.

In the horizontal federated learning setting, some embodiments may assume that all edge nodes agree on the features and feature splits. Therefore, for discrete features, there may be no joint categorization to be performed, since all edge nodes will already agree on the categories.

For continuous features, each edge node may communicate, to the central node, its respective minimum and maximum values of the given feature. The central node may then take the minimum of all minima that have been reported by the edge nodes, and the maximum of all maxima that have been reported by the edge nodes, to define a global range, spanning all the edge nodes, for that feature. This scheme reveals only the minimum and maximum of each Edge, which is not enough information to compromise the privacy of the Edges.

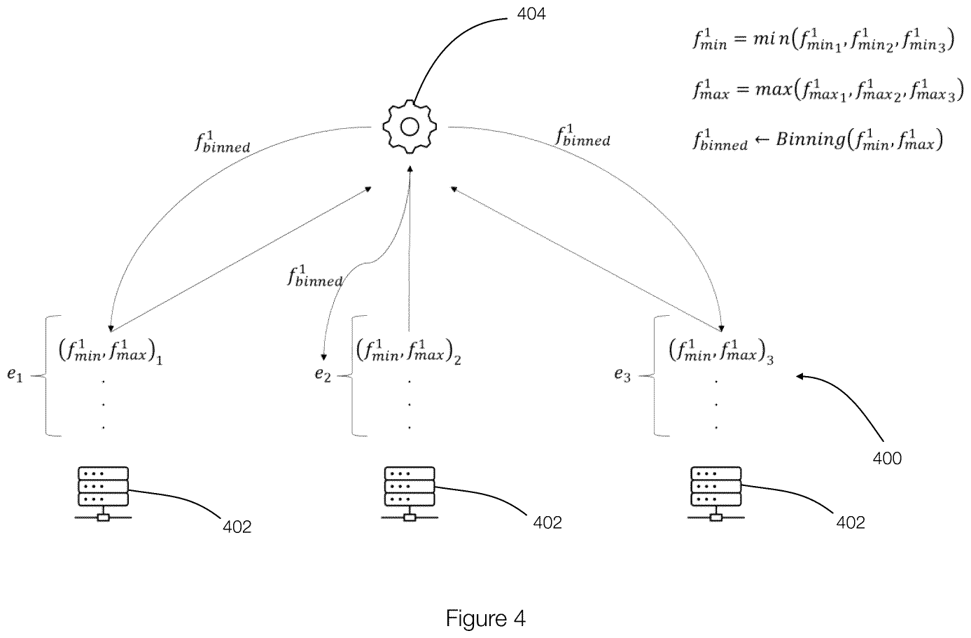

After having defined a global range for a given continuous feature, the central node may then calculate bins for this feature using any one of possible methods for binning. FIG. 4 discloses one example of a binning method 400 for one or more continuous features. In this example, the edge nodes 402 each transmit local minimum and maximum values of a feature to a central node 404. The central node 404 generates a global range (f_{binned}¹) back to the edge nodes 402. The global range is bounded by the minimum of the fₘᵢₙ¹ values received from the edge nodes 402 and the maximum of the fₘₐₓ¹ values received from the edge nodes 402.

One, non-limiting, example of a binning method is to uniformly split the continuous feature into K bins. Thus, the global range is split into K bins. Any method may be used that does not require Central to know the actual values for the feature, but only the range, that is, the global minimum and global maximum values. The actual method use for discretization may be determined using any suitable approach. Once a continuous feature has been categorized, these bin values, that is, the global minimum and global maximum, may be broadcast by the central node back to the edge nodes. The edge nodes may then use this information to perform splits on their respective private data samples.

As previously stated, classification purity measures during the construction of decision trees require: (i) counting the number of feature value occurrence (or bins for continuous features) per possible label and (ii) knowing the total number of samples per feature to normalize the sum into a probability. This is described in U.S. Ser. No. 17/937,225 filed September 30, 22 and titled HORIZONTAL FEDERATED FOREST VIA SECURE AGGREGATION, which application is incorporated by reference in its entirety.

Embodiments of the invention further relate to training random forest regressors, which may include constructing nodes of the decision trees, and includes aspects of calculating or determining purity measures. In one example, reduction in variance and mean squared error (MSE) are examples for splitting purity metrics for continuous target variables. In one example, the MSE includes calculating the average squared deviation from each target sample to the mean, which is the same as the variance.

Embodiments of the invention further relate to a framework that allows purity measures, including purity measures used in random forests regressors to be determined. This allows a common regression decision tree (and random forest regressors) to be constructed and trained in a private manner.

In one example, constructing a tree node includes calculating the impurity (or purity) (the splitting measure) for all feature splits. This may be performed with respect to all samples input to a given node in the decision tree.

Reduction in variance is a splitting metric that measures how much the variance reduces when considering different feature splits. The reduction in variance may be determined by:

$${argmin}_{fs} \frac{1}{\vert y \vert} {\sum }_{{y}_{fs} ∈ fs} \vert {y}_{fs} \vert var [ {y}_{fs} ] .$$

This formula can be used to determine a feature split fs that minimizes the weighted variance of its children tree nodes with respect to a target variable. The term y_{fs} is used to determine or calculate this minimum given the distributed nature of a federated learning scenario and privacy requirements.

In one example, the edge nodes will be sharing a global knowledge of the values for constructing the feature splits for all features. For each feature split, each of the edge nodes tracks:
Local cardinality of feature splits: |y_{fs}|;
Local sum (Θfs) of y_{fs}: Θ_{fs}=Σ_{yf∈fs}y_{fs}; and
Local sum of squares (Ξfs) of y_{fs}: Ξ_{fs}=Σ_{yfs∈fs} y_{fs}².

Stated differently, each of the edge nodes may perform multiple different feature splits. Information about the splits (federated variance data discussed below) is provided to the central node by each of the edge nodes. The central node can then use the federated variance data for all of the different splits to determine a global variance for each split. The split assigned to that node at all of the edge nodes is the split that corresponds to the lowest global variance.

Tracking these values allows the global variance to be computed securely without revealing edge data. For example, the centralized variance var, may be given by:

$${var}_{c} = \frac{1}{l} {\sum }_{i} {( {X}_{i} - {μ}_{c} )}^{2}$$

$$I {var}_{c} = {\sum }_{i} {( {X}_{i} )}^{2} - {\sum }_{i} 2 {X}_{i} {μ}_{c} + {\sum }_{i} {( {μ}_{c} )}^{2}$$

$$substituting {μ}_{c} = \frac{Θ}{n - 1}$$

$$I {var}_{c} = {\sum }_{i} {( {X}_{i} )}^{2} - 2 \frac{{Θ}^{2}}{I} + \frac{{Θ}^{2}}{I} + {\sum }_{i} {( {X}_{i} )}^{2} - \frac{{Θ}^{2}}{I}$$

Consequently,

$$I {var}_{c} = Ξ - \frac{{Θ}^{2}}{I}$$

This demonstrates that the global variance can be computed without requiring the edge nodes to provide specific samples. Rather, various sums may be provided to the central node and these sums can be used to determine the global variances. In example, varc determines the global variance for each possibility of a child node. To determine the global variance of the split, the global variances of the child nodes can be combined in a weighted manner (e.g., based on the number of total samples and number of samples directed to each of the possible child nodes.

As a result, the calculation of the variance can be calculated by keeping track of the cardinality, the local sum, and the local sum of squares. In some examples, I=(n−1).

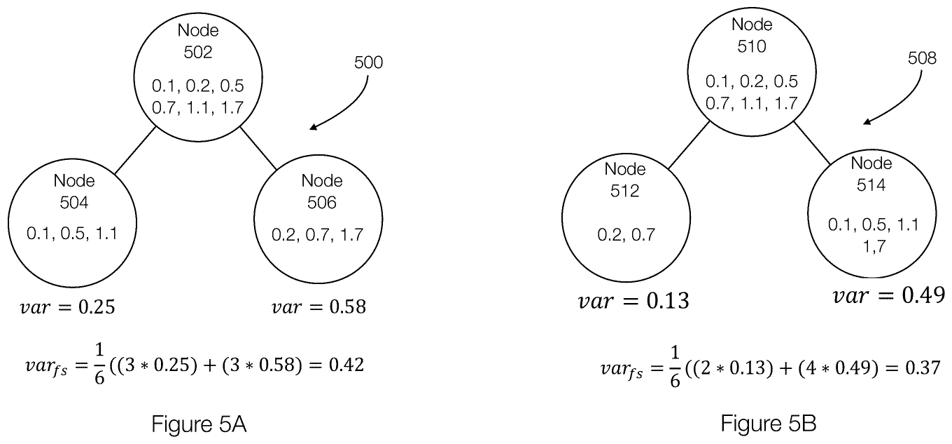

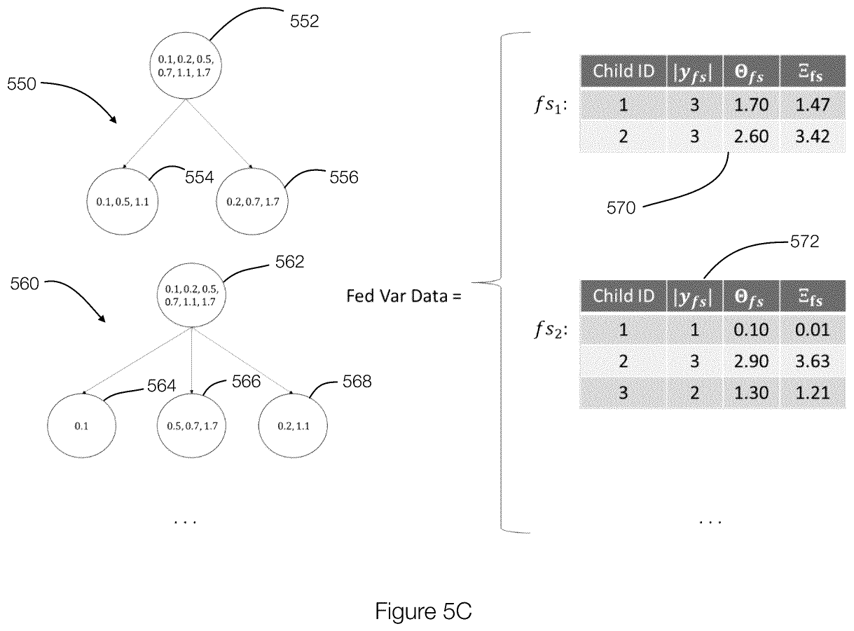

FIG. 5A discloses aspects of splitting a feature in a decision tree of a random forest regressor and illustrates aspects of constructing a node. The tree 500 includes a node 502 (a parent node) with two child nodes 504 and 506. In this example, the node 502 is being constructed and the child nodes 504 and 506 are present for purposes at least of evaluating the feature split. The samples received at the node 502 include 0.1, 0.2, 0.5, 0.7, 1.1, and 1.7. Based on a current split of a feature at the node 502, the samples 0.1, 0.5, and 1.1 are directed to the node 504 while the samples 0.2, 0.7, and 1.7 are directed to the node 506. The variance at the node 504 is 0.25 and the variance at the node 506 is 0.58.

FIG. 5B discloses aspects of splitting a feature in a decision tree of a regressive random forest and illustrates aspects of constructing a node. The decision tree 508 has a different split compared to the decision tree 500 and thus has a different variance. In FIG. 5B, the node 510 receives the same samples that were received at the node 502. However, the samples 0.2 and 0.7 were directed to the node 512 with a resulting variance of 0.13 while the samples 01, 0.5, 1.1, and 1.7 were directed to the node 514 with a resulting variance of 0.49. The total variance of the feature split for the tree 508 is thus 0.37. As a result, the feature split in the decision tree 508 is chosen as the best split with respect to the trees 500 and 508 in constructing the node 502 (or 510). This example illustrates an example of determining the variance of a feature split at the node 502. Embodiments of the invention may determine a global variance for the child nodes in the decision trees of multiple edge nodes and then determine a global variance for the split as illustrated in FIGS. 5A and 5B where the variances used in determining the global variance of the split are the global variances of the child nodes. The result may be returned to the edge nodes and implemented in the corresponding decision tree nodes.

More specifically, FIGS. 5A and 5B illustrate two different feature splits that were performed on the same node at the same edge node. Thus, the node 510 corresponds to the node 502 with a different split. FIGS. 5A and 5B illustrate how the total variance (calculated from the variances of the child nodes) can be used to select a feature split. Embodiments of the invention extend this concept to federated edge nodes in a manner that allows the feature split to be selected from the contributions of all the edge nodes without requiring the edge nodes to disclose their private data or samples.

FIG. 5C discloses aspects of sending federated data from edge nodes to a central node without disclosing private data or private samples. In this example, the tree 550 may be present at a first edge node and is associated with a first feature split. The tree 560 is associated with the same first edge node and represents a different feature split. The tree 550 includes a parent node 552 and child nodes 554 and 556. The tree 560 includes a parent node 562 and child nodes 564, 566, and 568.

The tree 550 thus represents a split of a first feature at a first edge node and the tree 560 represents a different split of the same first feature at the first edge node.

Rather than sending the values of the samples, the edge nodes may each generate or track federated variance data (for each feature split) that includes a local cardinality |y_{fs}|, a local sum of y_{fs}, which is Θ_{fs}, and a local sum of squares of y_{fs}, which is Ξ_{fs}.

The edge nodes provide their respective federated variance data to the central node. FIG. 5C illustrates federated data from different splits at a particular edge node. The federated variance data for the first split is represented in the table 570 and the federated variance data for the second split is represented in the table 572. The federated variance data in the table 570 is represented for the child nodes 554, and 556 based on the feature split performed at the parent node 552. Similarly, the data in the table 572 includes the federated variance data for the child nodes 564, 566, and 568 for the feature split performed at the parent node 562. The parent node 562 is the same as the parent node 552, but with a different feature split.

As illustrated for the tree 550, the federated variance data is collected for each of the child nodes. Thus, the cardinality for the child node 554 is 3. The local sum of the feature split (a sum of the values that ended up in the child node 554) is 1.7 or (1.7=0.1+0.5+1.1). The local sum of squares is 1.47 or (1.47=0.1²+0.5²+1.1²). Similar computations are performed for the other child nodes for each of the splits. These sums are illustrated in the tables 570 and 572.

The central node may aggregate the federated variance data from all of the edge nodes to calculate a global variance per feature split. FIG. 5C thus illustrates that the central node can collect federated variance data from multiple edge nodes without revealing specific sample values from the respective edge nodes. Each of the edge nodes sends all of its federated variance data to the central node.

In one example, a global variance is determined for each line (that is, for each child node) of each of the tables 570 and 572 as follows (I=|y_{fs}|):

$$I {var}_{c} = Ξ - \frac{{Θ}^{2}}{I}$$

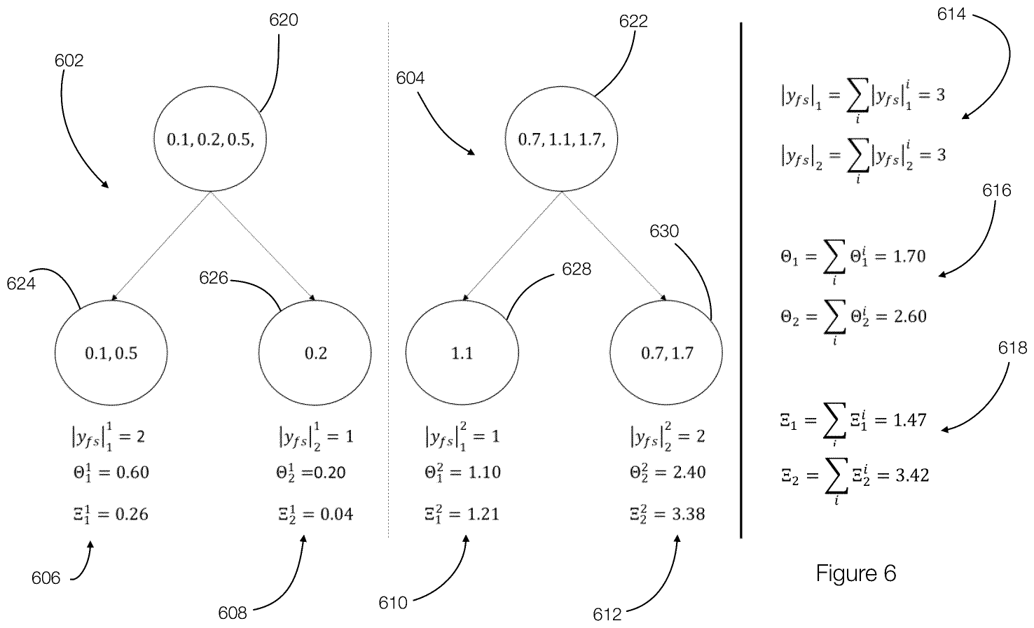

FIG. 6 discloses additional aspects of aggregating a given feature split data for different nodes at different edge nodes. The global variance formula is applied for each E, 0, and subscript. Thus, the sums are performed across edge nodes and generates one global variance per possibility of child node. Then, the global variance of the feature split itself is computed as the weighted average of the global variances of the possible child nodes.

The best feature split is then returned to all of the edge nodes. In other words, the feature split that yielded the smallest global variance is returned to the edge nodes and implemented in the relevant node of the decision tree.

More specifically, a global variance is calculated for each feature split (using the global variances of its generated child nodes. The feature split that yields the lowest total variance for the child nodes is the one with the highest purity. This is the feature split that will be used by all the nodes across the edge nodes to split the data and generate the child nodes.

This is, in general, a generate and test procedure, where may possibilities of splitting the data at all the different features may be performed. This could be performed at the central node, but embodiments of the invention do not share local data amongst the edge nodes or with the central node. Thus, each edge node performs multiple splits and collects the proxy data (federated variance data) that is provided to the central node to determine the global variance for each possible feature split.

In FIG. 6, the subscripts index child tree nodes and the superscript indexes edge nodes. FIG. 6 further illustrates two decision trees at different edge nodes. In this example, the tree 602 performs the same split as the decision tree 604. The federated variance data of the tree 602 (more specifically in the context of constructing the node 620) includes the federated variance data 606 for the left child node and the federated variance data 608 for the right child node. The federated variance data of the tree 604 (more specifically in the context of constructing the node 622) includes the federated variance data 610 for the left child node and the federated variance data 612 for the right child node of the tree 604.

The federated variance data 606, 608, 610, 612 may be transmitted to the central node and accumulated in tables. As previously stated, the federated variance data 606, 608, 610, and 612 does not include specific data values or samples. As a result, the data of the edge nodes remains private and is not shared. The federated variance data, however, can be used to determine the global variance of the feature split in question.

The federated variance data 614 is aggregated, at the central node, for the edge nodes in FIG. 6. For the child nodes 624 and 628, the cardinality is summed and is 3 in this example. The cardinality for the child nodes 626 and 630 is also 3 in this example. The sum of the samples, as illustrated in the federated variance data 616, sent from the nodes 624 and 628 based on the feature split is 1.70 (1.70=0.1+0.5+1.1) and the sum of the values sent from the nodes 626 and 630 based on the feature split is 2.60 (2.60=0.2+0.7+1.7). The sum of the squares of the values in the nodes 624 and 628, as illustrated in the federated variance data 618, is 1.47 (1.47=0.1²+0.5²+1.1²). The sum of the squares of the values in the nodes 626 and 630 is 3.42 (3.42=0.2²+0.7²+1.7²).

This example illustrates an example of determining a global variance for a feature split based on federated variance data from decision tree nodes being constructed at two edge nodes. The split is the same at each of the two edge nodes. After determining the global variance for the child nodes, the global variance for the feature split is determined using, by way of example, the formula shown in FIGS. 5A-5B. Once these sums have been determined by summing the federated variance data from all of the edge nodes, the global variance of each node i (the possible child nodes), in this example, can be determined as follows:

$${var}_{i} = \frac{Ξ - \frac{{Θ}^{2}}{I}}{I}$$

Applying this to FIG. 6 results in the following:

$${var}_{1} = \frac{1.47 - \frac{{1.7}^{2}}{3}}{3} = \text{.169} and$$

$${var}_{2} = \frac{3.42 - \frac{{2.6}^{2}}{3}}{3} = \text{.389}$$

Then, the global variance of the feature split, which in this example is a weighted combination (e.g., average) of the global variances of the possible child nodes, is computed as follows:

$${var}_{fs} = \frac{1}{6} ( ( 3 * 0.169 ) + ( 3 * \text{.389} ) )$$

In this example:
   |y_{fs1}|=3
   |y_{fs2}|=3
   |y_{fs1}|+|y_{fs2}|=6

Such global variance is calculated for each possible feature split, at the central node. The feature split with the smallest global variance would be selected and implemented at each of the decision trees in each of the edge nodes.

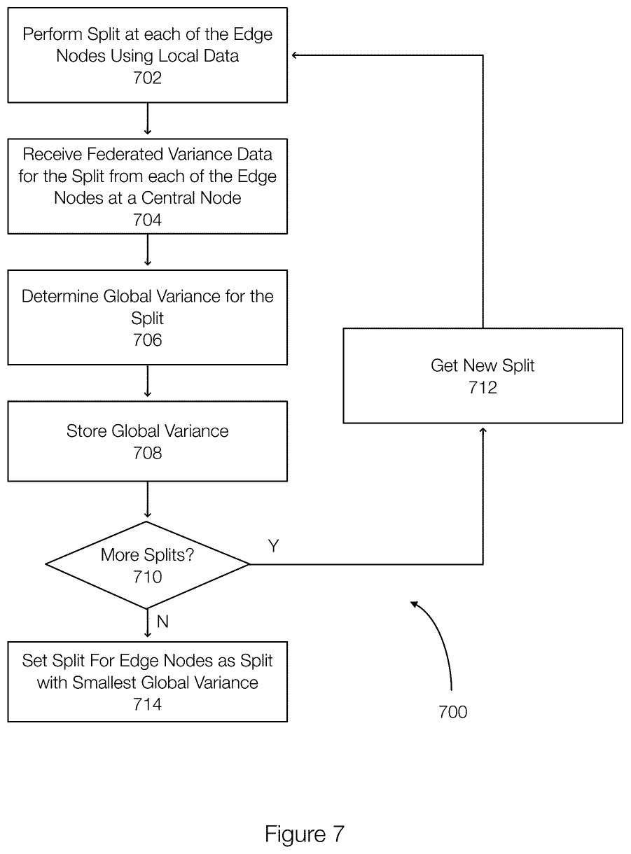

FIG. 7 discloses aspects of determining a global variance. The method 700 is illustrated for a specific split that is the same at each edge node. The method 700 is typically performed multiple times for multiple splits at each of multiple edge nodes. The federated variance data corresponding to a particular split is aggregated at the central node. This allows the central node to compare the global variances of all the splits. The split selected and implemented at each of the edge nodes for the relevant decision tree node is the split with the smallest global variance.

The method 700 illustrates a sequential implementation for generating federated variance data for multiple splits. However, the process of generating federated variance data for each of multiple splits may be performed in parallel at the edges such that all of the federated variance data is transmitted at the same time or in stages.

In the method 700, a split (the same split) is performed 702 at each of the edge nodes for a node of a decision tree under construction. The split is performed using local data and, after performing the split, federated variance data is generated for each of the child nodes of the decision tree. The federated variance data is transmitted to and received 704 by the central node for that split. The global variance for this specific split is determined 706 and stored. If another split is to be performed (Y at 710), the new split is determined 712 and set at each of the edge nodes. This allows a global variance to be determined for another split. When there are no more splits (N at 710), the split for the node being constructed at each of the edge nodes is set 714 to be the split with the smallest global variance. Then, the next node in the decision tree can be constructed.

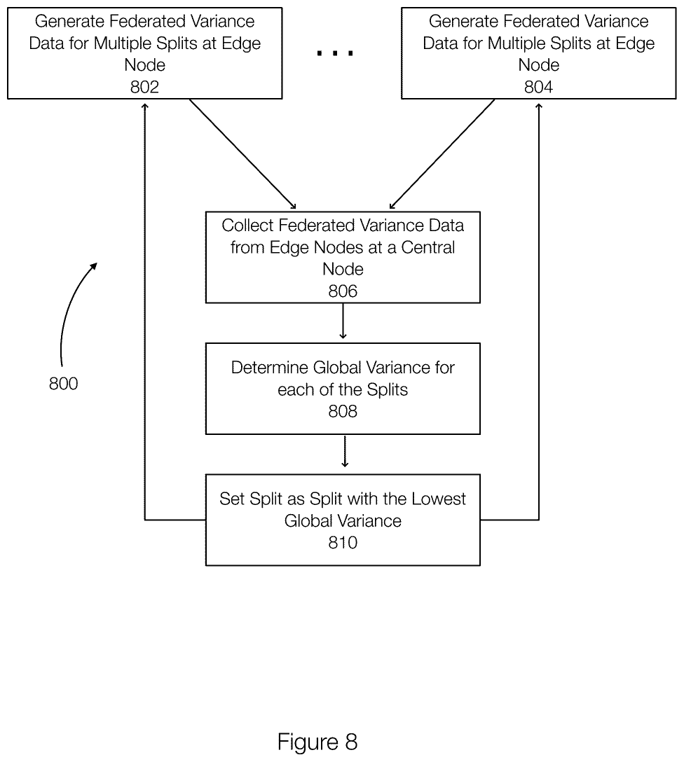

FIG. 8 discloses additional aspects of determining a split for a decision tree in a random forest regressor in a federated learning system. The method 800 illustrates that multiple splits are performed at each of the edge nodes in a federated learning system. Performing the splits is represented as being performed at each of the edge nodes individually at elements 802 and 804. As previously stated, each of the edge nodes performs splits using local data that is not shared.

Rather, each of the edge nodes generates federated variance data, which is then collected 806 at the central node. The central node determines 808 a global variance for each split. The split selected for the node of the decision trees being constructed at the edge nodes is the split with the lowest global variance. Thus, the split is set 810 at the same node in the same decision tree at all of the edge nodes based on the lowest global variance.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, some embodiments of the invention may help to ensure the fairness, and transparency, of a machine learning model, while preserving the privacy of data used in the training of the model. Thus, some embodiments may be particularly useful in the context of machine learning models that are used to screen job candidates and make hiring recommendations, although the scope of the invention is not limited to this example application. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, regression related operations, random forest regressor training operations, decision tree node operations, federated learning operations, or the like. More generally, the scope of the invention embraces any operating environment in which the disclosed concepts may be useful.

New and/or modified data collected and/or generated in connection with some embodiments, may be stored in a computing environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations and services initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, VMs, containers or any combination of these, though no particular device implementation or configuration is required for any embodiment. Similarly, data protection system components such as databases, storage servers, storage volumes (LUNs), storage disks, services, servers, or the like, for example, may likewise take the form of software, physical machines or virtual machines (VMs) or containers, though no particular component implementation is required for any embodiment.

It is noted that any operation(s) of any of the methods discloses herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Embodiment 1. A method comprising: receiving federated variance data from multiple edge nodes for each of multiple splits, wherein each split is associated with a node of a decision tree, determining a global variance for each of the splits at a central node, selecting a split with a lowest global variance from among the global variances, and setting the selected split at the node of the decision tree at each of the edge nodes.

Embodiment 2. The method of embodiment 1, further comprising generating the federated variance data at each of the edge nodes, wherein each of the edge nodes generates the federated variance data based on their own local data.

Embodiment 3. The method of embodiment 1 and/or 2, wherein the local data of the edges nodes is not shared with other edge nodes or with a central node.

Embodiment 4. The method of embodiment 1, 2, and/or 3, wherein each of the edge nodes generates the federated variance data for each of multiple splits, wherein the multiple splits are the same at each of the edge nodes.

Embodiment 5. The method of embodiment 1, 2, 3, and/or 4, wherein the federated variance data includes a local cardinality for each of the feature splits, a local sum of the feature splits, and a local sum of squares of the feature splits.

Embodiment 6. The method of embodiment 1, 2, 3, 4, and/or 5, further comprising aggregating the federated variance data at the central node.

Embodiment 7. The method of embodiment 1, 2, 3, 4, 5, and/or 6, wherein the lowest global variance represents a best purity for the split.

Embodiment 8. The method of embodiment 1, 2, 3, 4, 5, 6, and/or 7, further comprising constructing multiple decision trees that are the same at each of the edge nodes.

Embodiment 9. The method of embodiment 1, 2, 3, 4, 5, 6, 7, and/or 8, wherein the multiple decision trees constitute a random forest regressor.

Embodiment 10. The method of embodiment 1, 2, 3, 4, 5, 6, 7, 8, and/or 9, further comprising sharing values for constructing each feature split for all features.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

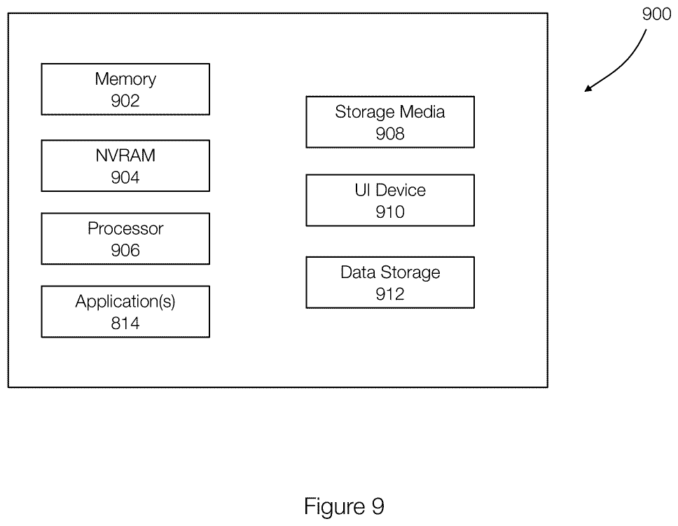

With reference briefly now to FIG. 9, any one or more of the entities disclosed, or implied, by the Figures, and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, Ul device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 900 may also be representative of an edge system, a cloud-based system, a server cluster, or the like or other computing system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving federated variance data from multiple edge nodes for each of multiple splits, wherein each split is associated with a node of a decision tree;
determining a global variance for each of the splits at a central node;
selecting a split with a lowest global variance from among the global variances; and
setting the selected split at the node of the decision tree at each of the edge nodes.

2. The method of claim 1, further comprising generating the federated variance data at each of the edge nodes, wherein each of the edge nodes generates the federated variance data based on their own local data.

3. The method of claim 2, wherein the local data of the edges nodes is not shared with other edge nodes or with a central node.

4. The method of claim 2, wherein each of the edge nodes generates the federated variance data for each of multiple splits, wherein the multiple splits are the same at each of the edge nodes.

5. The method of claim 1, wherein the federated variance data includes a local cardinality for each of the feature splits, a local sum of the feature splits, and a local sum of squares of the feature splits.

6. The method of claim 1, further comprising aggregating the federated variance data at the central node.

7. The method of claim 1, wherein the lowest global variance represents a best purity for the split.

8. The method of claim 1, further comprising constructing multiple decision trees that are the same at each of the edge nodes.

9. The method of claim 8, wherein the multiple decision trees constitute a random forest regressor.

10. The method of claim 1, further comprising sharing values for constructing each feature split for all features.

11. A non-transitory storage medium having stored therein instructions that are executable by one or more hardware processors to perform operations comprising:
receiving federated variance data from multiple edge nodes for each of multiple splits, wherein each split is associated with a node of a decision tree;
determining a global variance for each of the splits at a central node;
selecting a split with a lowest global variance from among the global variances; and
setting the selected split at the node of the decision tree at each of the edge nodes.

12. The non-transitory storage medium of claim 11, further comprising generating the federated variance data at each of the edge nodes, wherein each of the edge nodes generates the federated variance data based on their own local data.

13. The non-transitory storage medium of claim 12, wherein the local data of the edges nodes is not shared with other edge nodes or with a central node.

14. The non-transitory storage medium of claim 12, wherein each of the edge nodes generates the federated variance data for each of multiple splits, wherein the multiple splits are the same at each of the edge nodes.

15. The non-transitory storage medium of claim 11, wherein the federated variance data includes a local cardinality for each of the feature splits, a local sum of the feature splits, and a local sum of squares of the feature splits.

16. The non-transitory storage medium of claim 11, further comprising aggregating the federated variance data at the central node.

17. The non-transitory storage medium of claim 11, wherein the lowest global variance represents a best purity for the split.

18. The non-transitory storage medium of claim 11, further comprising constructing multiple decision trees that are the same at each of the edge nodes.

19. The non-transitory storage medium of claim 18, wherein the multiple decision trees constitute a random forest regressor.

20. The non-transitory storage medium of claim 11, further comprising sharing values for constructing each feature split for all features.
